(19) United States
(12) Patent Application Publication
(10) Pub. No.: US 2020/0143536 A1
(43) Pub. Date: May 7, 2020

(54) METHODS AND SYSTEMS FOR EVALUATING AND REDUCING MYOPIC POTENTIAL OF DISPLAYED COLOR IMAGES

(71) Applicants: UNIVERSITY OF WASHINGTON, Seattle, WA (US); WAVESHIFT LLC, Palo Alto, CA (US)

(72) Inventors: James Kuchenbecker, Seattle, WA (US); Jay Neitz, Seattle, WA (US); Thomas W. Chalberg, Jr., Menlo Park, CA (US)

(21) Appl. No.: 16/630,825

(22) PCT Filed: Jul. 13, 2018
(86) PCT No.: PCT/US2018/042030

§ 371 Date: Jan. 13, 2020

Related U.S. Application Data
(60) Provisional application No. 62/532,888, filed on Jul. 14, 2017.

(51) Int. Cl. G06T 7/00; G06K 9/00; G09G 3/20

(52) U.S. Cl. CPC G06T 7/0012; G06K 9/0061; G06T 2207/30041; G06T 2207/10024; G09G 3/2003

(57) ABSTRACT

Evaluating differential stimulation of L and M cones in a viewer's eye by an image displayed on a color display includes receiving information about the spectral emission properties of the display; receiving image data; determining an achromatic component of the image based on image data and information about the spectral emission properties of the display, the achromatic component representing differential stimulation of L and M cones due to contrast variations in the image; determining a chromatic component of the image based image data and information about the spectral emission properties of the color display, this component representing differential stimulation of L and M cones due to spectral content of the image; and evaluating the differential stimulation of L and M cones based on the chromatic and achromatic components.

### CROSS-REFERENCE TO RELATED APPLICATIONS

This application is a non-provisional of and claims priority to U.S. Provisional Patent Application No. 62/532,888, filed on Jul. 14, 2017, the entire contents of which are hereby incorporated by reference.

### BACKGROUND

Electronic displays are ubiquitous in today's world. For example, mobile devices such as smartphones and tablet computers commonly use a liquid crystal display (LCD) or an organic light emitting diode (OLED) display. LCDs and OLED displays are both examples of flat panel displays, and are also used in desktop monitors, TVs, and automotive and aircraft displays.

Many color displays, including many LCD and OLED displays, spatially synthesize color. In other words, each pixel is composed of three sub-pixels that provide a different color. For instance, each pixel can have a red, green, or blue sub-pixel, or a cyan, magenta, or yellow sub-pixel. The color of the pixel, as perceived by a viewer, depends upon the relative proportion of light from each of the three sub-pixels.

Color information for a display is commonly encoded as an RGB signal, whereby the signal is composed of a value for each of the red, green, and blue components of a pixel color for each signal in each frame. A so-called gamma correction is used to convert the signal into an intensity or voltage to correct for inherent non-linearity in a display, such that the intended color is reproduced by the display.

Humans perceive color in response to signals from photoreceptor cells called cone cells, or simply cones. Cones are present throughout the central and peripheral retina, being most densely packed in the fovea centralis, a 0.3 mm diameter rod-free area in the central macula. Moving away from the fovea centralis, cones reduce in number towards the periphery of the retina. There are about six to seven million cones in a human eye.

Humans normally have three types of cones, each having a response curve peaking at a different wavelength in the visible light spectrum. FIG. 1A shows the response curves for each cone type. Here, the horizontal axis shows light wavelength (in nm) and the vertical scale shows the responsivity. In this plot, the curves have been scaled so that the area under each cone is equal, and adds to 10 on a linear scale. The first type of cone responds the most to light of long wavelengths, peaking at about 560 nm, and is designated L for long. The spectral response curve for L cones is shown as curve A. The second type responds the most to light of medium-wavelength, peaking at 530 nm, and is abbreviated M for medium. This response curve is curve B in FIG. 1A. The third type responds the most to short-wavelength light, peaking at 420 nm, and is designated S for short, shown as curve C. The three types have typical peak wavelengths near 564-580 nm, 534-545 nm, and 420-440 nm, respectively; the peak and absorption spectrum varies among individuals. The difference in the signals received from the three cone types allows the brain to perceive a continuous range of colors, through the opponent process of color vision.

In general, the relative number of each cone type can vary. Whereas S-cones usually represent between 5-7% of total cones, the ratio of L and M cones can vary widely among individuals, from as low as 5% L/95% M to as high as 95% L/5% M. The ratio of L and M cones also can vary, on average, between members of difference races, with Asians believed to average close to 50/50 L:M and Caucasians believed to average close to 63% L cones (see, for example, U.S. Pat. No. 8,951,729). Color vision disorders also impact the proportion of L and M cones; protanopes have 0% L cones and deuteranopes have 0% M cones.

Referring to FIG. 1B, cones are generally arranged in a mosaic on the retina. In this example, L and M cones are distributed in approximately equal numbers, with fewer S cones. Accordingly, when viewing an image on an electronic display, the response of the human eye to a particular pixel will depend on the color of that pixel and where on the retina the pixel is imaged.

Humans are generally born hyperopic, which means that their eyes are too short in axial length for the optical power of the cornea. This physical eye geometry results in at-infinity images entering the eye coming into focus behind the retina. In infants, the malleable lens can add enough positive power to move the focal plane forward such that it lands on the retina.

Emmetropia refers to the point where the cornea's refractive power is matched to the location of the retina, such that images at infinity optics are in focus. Since we are born hyperopic, the eye must reach emmetropia by growing until the sclera permanently hardens. This requires a careful balance between rate of eye growth and the hardening of the sclera. The process describing the axial elongation of the eye and stopping at emmetropia is called emmetropization.

Myopia is caused when external factors tip the balance between axial elongation and scleral hardening toward axial elongation. By the time the sclera hardens in early adulthood, the eye has grown too long and a mismatch exists between the location of the retina compared to the minimum refractive power of the cornea. Parallel wave-fronts entering the eye form an image in the intravitreal space instead of on the retina. Since the lens of the eye can only add positive power, the eye cannot form in-focus images on the retina without external negative power lenses (e.g., by using glasses).

Environmental factors, such as close work and screen time, have long been understood to be contributing factors to the emmetropization process going awry.

### SUMMARY

Recent discoveries have provided insights into the mechanism behind the signals that control eye growth, which can allow for prediction of whether someone will become myopic. Based on this understanding, the inventors have developed a model of eye growth related signals which can provide a predictive framework to return a quantity representing an amount of “myopic potential” contained within an image. Here, myopic potential refers to the amount of differential stimulation a displayed image causes to L and M cones in a viewer's eye. High differential stimulation has a proportionally high myopic potential because the differential stimulation is believed to stimulate eye-growth beyond emmetropia. The recent discoveries in this regard are discussed, for example, in the following patent applications, the contents of which are incorporated herein by reference: U.S. 2011/0313058A1, entitled “METHOD AND APPARATUS FOR LIMITING GROWTH OF EYE LENGTH,” filed Dec. 21, 2009; U.S. 2014/0063347A1, entitled “MYOPIA-SAFE VIDEO DISPLAYS,” filed Apr. 20, 2012; U.S. 2015/0111782A1, entitled “METHODS FOR DIAGNOSING AND TREATING EYE-LENGTH RELATED DISORDERS,” filed Dec. 23, 2014; U.S. Ser. No. 15/409,049, entitled “METHODS FOR DISPLAYING AN E-BOOK USING A COMBINATION OF COLORS FOR TEXT AND BACKGROUND THAT HAVE A REDUCED MYOPIAGENIC EFFECT,” filed Jan. 18, 2017; and PCT/US2017/013969 entitled “METHOD AND APPARATUS FOR REDUCING MYOPIAGENIC EFFECT OF ELECTRONIC DISPLAYS,” filed Jan. 18, 2017.

The disclosed predictive frame work uses various information to provide a score for myopic potential, including, e.g., information about a spectral environment (including, most commonly, RGB displays), geometries of viewing setups, L:M cone ratios, different cone spacings, age of human lens, spectral peak of allele for L- and M-cones, and a modulation transfer function for the cornea. The score returned is independent of time, but frames over time (e.g., watching a movie) can be accumulated. Content can be anything from, but not limited to, video games, movies, television shows, still images, video images, text, presentations, patterns, and shapes. Displays can be found on anything from, but not limited to, smart phones, tablets, laptops, desktops, televisions, and e-readers.

It is known in the art that exposure to outdoor sunlight is not a risk factor for myopia (see, for example Jones, L. A. et al. Invest. Ophthalmol. Vis. Sci. 48, 3524-3532 (2007)). Sunlight is considered an equal energy (EE) illuminant because it does not trigger the opponent color visual system (i.e., sunlight is neither red nor green, and neither blue nor yellow). The EE illuminant represents a ‘white point’ in the CIE 1931 color space diagram, which is shown in FIG. 1C. As opposed to visual exposure to EE illumination like sunlight, it was recently described that excessive stimulation of L cones relative to M cones can lead to asymmetric growth in a developing human eye, leading to myopia (see, patent application WO 2012/145672 A1). This has significant implications for electronic displays, which are conventionally optimized to display images with deeply saturated colors, including reds, and high contrast. It is believed that the myopiagenic effect of displays may be reduced by reducing the saturation of red-hued pixels in an image, or reducing the relative amount of red to green in a pixel's color, particularly in those pixels where the amount of red exceeds the amount of green.

A more recent discovery stipulates that overall contrast between neighboring cones stimulates asymmetric growth of the eye, leading to myopia. This could be, for example, excessive stimulation of L cones over M cones, but is not limited to that type of contrast alone. The discovery further stipulates that difference in stimulation in neighboring cones is critical, as opposed to the overall ratio of L vs. M over the entire retina.

When a high contrast image falls upon the retina, edges in the image are detected in the visual system by center-surround antagonism in a receptive field on the retina. Thus images with many edges can be said to contain high contrast, causing signaling differences between adjacent neurons in the retina (cone photoreceptors and their downstream signaling partners, including bipolar cells and retinal ganglion cells), which highly activate center-surround antagonism in the visual system. Similarly, when an image containing saturated red, which is composed primarily of long wavelength light, falls upon the retina, it strongly stimulates L cones but not M cones or S cones. Each L cone, where surrounded by a number of M cones and/or S cones, acts as a highly stimulated “center” whereas the M or S cones in the “surround” are stimulated to a much lesser degree. In this way, saturated red colors can be said to provide high contrast among adjacent retinal neurons and can be said to activate a high degree of center-surround antagonism. Because high contrast causes high signaling differences between adjacent cones and other neurons in the visual system, and cause high center-surround antagonism in the visual system, these terms are used interchangeably to describe the degree of contrast within a receptive field on the retina.

Various aspects of the invention are summarized below.

In general, in one aspect, the invention features a method for evaluating differential stimulation of L and M cones in a viewer's eye by an image displayed on a color display. The method includes receiving information about the spectral emission properties of the color display; receiving image data about the image; determining an achromatic component of the image based on one or more pixels of the image and the information about the spectral emission properties of the color display, the achromatic component representing differential stimulation of L and M cones due to contrast variations in the image; determining a chromatic component of the image based on one or more pixels of the image and the information about the spectral emission properties of the color display, the chromatic component representing differential stimulation of L and M cones due to a spectral content of the image; and evaluating the differential stimulation of L and M cones in the viewer's eye by the image displayed on the color display based on the chromatic and achromatic components.

Implementations of the method can include one or more of the following features and/or features of other aspects. For example, the method can include adjusting a color setting of the color display and displaying the image on the color display, wherein the adjusted color setting causes the displayed image to cause a lower differential stimulation of L and M cones in the viewer's eye relative to displaying the image using the unadjusted display.

The evaluation can include using a first modulation transfer function to represent how the viewer's retina responds to different spatial frequencies present in the achromatic component for the image. In some embodiments, the evaluation further includes using a second modulation transfer function to represent how the viewer's eye blurs light as a function of spatial frequency.

The evaluation can include using a third modulation transfer function to represent how the viewer's retina responds to different spatial frequencies present in the chromatic component of the image. The first and third modulation transfer functions can represent a receptive field of a midget bipolar cell (e.g., difference of gaussians operator, cone specific gaussian operator).

Determining the achromatic component can include creating an achromatic corneal sensitivity profile for the viewer's eye based on a ratio of L cones to M cones in the viewer's eye and determining the chromatic component includes creating a chromatic corneal sensitivity profile for the viewer's eye based on a ratio of L cones to M cones in the viewer's eye, the achromatic corneal sensitivity profile being indicative of a combined sensitivity of the M cones and L cones in the viewer's eye and the chromatic corneal sensitivity profile being indicative of a differential sensitivity of the M cones and L cones in the viewer's eye. In some embodiments, the ratio of L cones to M cones in the viewer's eye is obtained from a measurement of the viewer's eye. Determining the achromatic component can include generating an achromatic representation of the image based on the achromatic corneal sensitivity profile and the spectral emission properties of the color display, and determining the chromatic component includes generating an achromatic representation of the image based on the chromatic corneal sensitivity profile and the spectral emission properties of the color display. The achromatic and chromatic components can account for light absorption by the lens of the viewer's eye. Evaluating the differential stimulation of L and M cones in the viewer's eye by the image can include determining a spatial frequency spectrum of the achromatic representation of the image.

In some embodiments, the information about the spectral emission properties of the color display include a spectral profile for each sub-pixel color of the color display. The color display can include red, green, and blue sub-pixel colors or cyan, magenta, and violet sub-pixel colors.

The image data can include a value for each sub-pixel display color for each pixel in the image. The sub-pixel display colors can be red, green, and blue or cyan, magenta, and violet.

In some embodiments, the image includes text. For example, the image can be a page of text.

The method can include providing information the viewer about a myopic potential of the image when viewed on the display based on the evaluation.

In general, in another aspect, the invention features a system that includes an electronic processing module programmed to: receive information about spectral emission properties of a color display; receive image data about an image; determine an achromatic component of the image based on one or more pixels of the image and the information about the spectral emission properties of the color display, the achromatic component representing differential stimulation of L and M cones due to contrast variations in the image; determine a chromatic component of the image based on one or more pixels of the image and the information about the spectral emission properties of the color display, the chromatic component representing differential stimulation of L and M cones due to a spectral content of the image; and evaluate differential stimulation of L and M cones in a viewer's eye by the image displayed on the color display based on the chromatic and achromatic components. Embodiments of the system can include one or more of the features of other aspects.

In general, in a further aspect, the invention features a method for presenting an image using a color display. The method includes receiving information about the spectral emission properties of the color display; receiving image data about the image; calculating information indicative of an amount of differential stimulation of L and M cones in a viewer's eye when viewing the image on the display based on the spectral emission properties of the display; identifying one or more color settings for the color display to reduce differential stimulation of L and M cones in the viewer's eye when the viewer view's the image using the color display; and transmitting the one or more color settings to the display.

Implementations of the method can include one or more of the following features and/or features of other aspects. For example, the method can include receiving information about a subject's L:M cone ratio, wherein the information indicative of an amount of differential stimulation of L and M cones in a viewer's eye when viewing the image on the display is calculated based on the L:M cone ratio.

In general, in another aspect, the invention features a method for displaying an e-book using a combination of colors for text and background that have a reduced differential stimulation of L and M cones in a viewer's eye compared to black text on white background. The method includes determining one or more combinations of colors for the text and background for the user based on spectral emission information of the e-book and information about the L:M cone ratio of the viewer, the combinations having a differential stimulation of L and M cones in the viewer's eye that is reduced compared to black text on white background; presenting the user with the one or more combinations of colors; receiving a selection of one of the color combinations from the user; and displaying the e-book file using the combination of colors for the text and background selected by the user.

Implementations of the method can include one or more of the following features and/or features of other aspects. For example, the method can include receiving information about a desired myopiagenic level from the user and presenting the one or more combinations of colors according to the received information, the presented combinations of colors having a myopic potential corresponding to the desired level.

The e-book can be a file in a format selected from the group composed of: Broadband eBooks (BBeB), Comic Book Archive, Compiled HTML, DAISY, DjVu, DOC, DOCX, EPUB, eReader, FictionBook, Founder Electronics, HTML, iBook, IEC62448, INF, KF8, KPF, Microsoft LIT, MOBI, Mobipocket, Multimedia eBooks, Newton eBook, Open Electronic Package, PDF, Plain text, Plucker, PostScript, RTF, SSReader, Text Encoding Initiative, TomeRaider, and Open XML Paper Specification.

The e-book can be displayed on a mobile device, such as a smartphone, a tablet computer, or a dedicated e-reader.

Among other advantages, the disclosed implementations can be used to evaluate myopic potential of an image when viewed by a specific individual on a specific device. The evaluation can be used to modify the image to reduce its myopic potential.

### BRIEF DESCRIPTION OF THE DRAWINGS

FIG. 1A is a plot showing normalized responsivity spectra of human cone cells, S, M, and L types.

FIG. 1B shows an example of cone mosaic on a retina.

FIG. 1C is CIE 1931 chromaticity diagram showing equal energy illuminant points CIE-E, CIE-D65, and CIE-C.

FIGS. 2A-2B show side cross-sections of a myopic eye and a normal eye, respectively.

FIG. 3 is a plot showing normalized spectral emission profiles for the red primary for four different devices.

FIG. 4 shows a flowchart of an algorithm for calculating a myopic potential of an image.

FIG. 5A is an example of a color image.

FIG. 5B shows the same image as shown in FIG. 5A in grayscale, where the grayscale intensity corresponds to the achromatic myopic potential component.

FIG. 5C shows the same image as shown in FIG. 5A, illustrating the chromatic contrast in the image.

FIG. 6A and FIG. 6B are plots showing sensitivity as a function of wavelength for the achromatic and chromatic operators, respectively.

FIGS. 7A-7D are plots showing the normalized activity as a function of spatial frequency (cycles per degree) of the modulation transfer functions for the eye, achromatic operator, combined eye and achromatic operator, and the chromatic operator, respectively.

FIG. 8 is a flowchart showing an algorithm for providing optimal settings for displaying an image with a reduced myopic potential.

FIG. 9 is a flowchart showing an algorithm for displaying an e-book with a combination of colors for text and background that have a reduced myopic potential compared to black text on white background.

FIG. 10. is a schematic diagram of an electronic processing module.

Like reference numbers and designations in various drawings indicate like elements.

### DETAILED DESCRIPTION

Referring to FIGS. 2A and 2B, myopia—or nearsightedness—is a refractive effect of the eye in which light entering the eye produces image focus in front of the retina, as shown in FIG. 2A for a myopic eye, rather than on the retina itself, as shown in FIG. 2B for a normal eye. It is believed that television, reading, indoor lighting, video games, and computer monitors all cause progression of myopia, particularly in children, because those displays produce stimuli that cause uneven excitation of L and M cones (for example, stimulating L cones more than M cones) and/or uneven excitation of neighboring cones in the retina. During childhood (approximately age 8), adolescence (before age 18), and young adulthood (until age 25 years or age 30 years), these factors of differential stimulation result in abnormal elongation of the eye, which consequently prevents images from be focused on the retina.

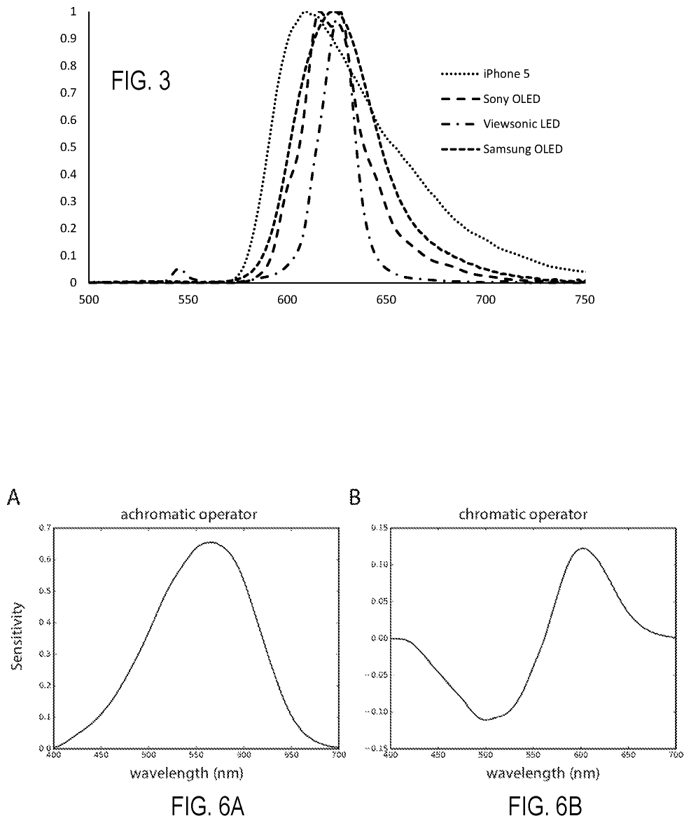

Color electronic displays typically use three colors to generate color images. Most commonly, red (R), green (G), and blue (B), are used as the three primaries, although yellow (Y), magenta (M), and violet (V) can be used as an alternative set of primaries. The three primaries' spectral shapes, peaks, and dominant wavelengths can vary from device to device, but are confined by the human visual system such that when R=G=B an achromatic percept is seen, when R=G the percept of yellow is seen, and when B is on by itself the percept of blue is seen. Meeting these perceptual requirements all but ensures red primaries on displays will release most of its energy at emissions greater than ˜590 nm. Nevertheless, different types of display may have different spectral profiles for each primary. For example, as illustrated in the plot in FIG. 3, the red primaries from four different devices demonstrate variation between both the peak wavelength and the peak width (e.g., FWHM) for each of these devices. Accordingly, the same image may have a different myopia potential depending on the display used to view the image.

Furthermore, individuals can have differing proportions of L-cones to M-cones on their retina. Accordingly, a particular image viewed on a specific device may have a different myopic potential for different users.

However, in general, it is believed that the myopic potential of a displayed image is based on the amount of contrast as seen by the eye. The eye itself has both optical properties and sampling properties which governs the amount of contrast in an image as it relates to myopia. Mathematically, the optical properties and sampling mosaic can be modelled by separating the image content into an “achromatic” and a “chromatic” representation, both of which are discussed in more detail below. It is believed that these representations are analogous to parallel pathways present at the ganglion cell level in the eye.

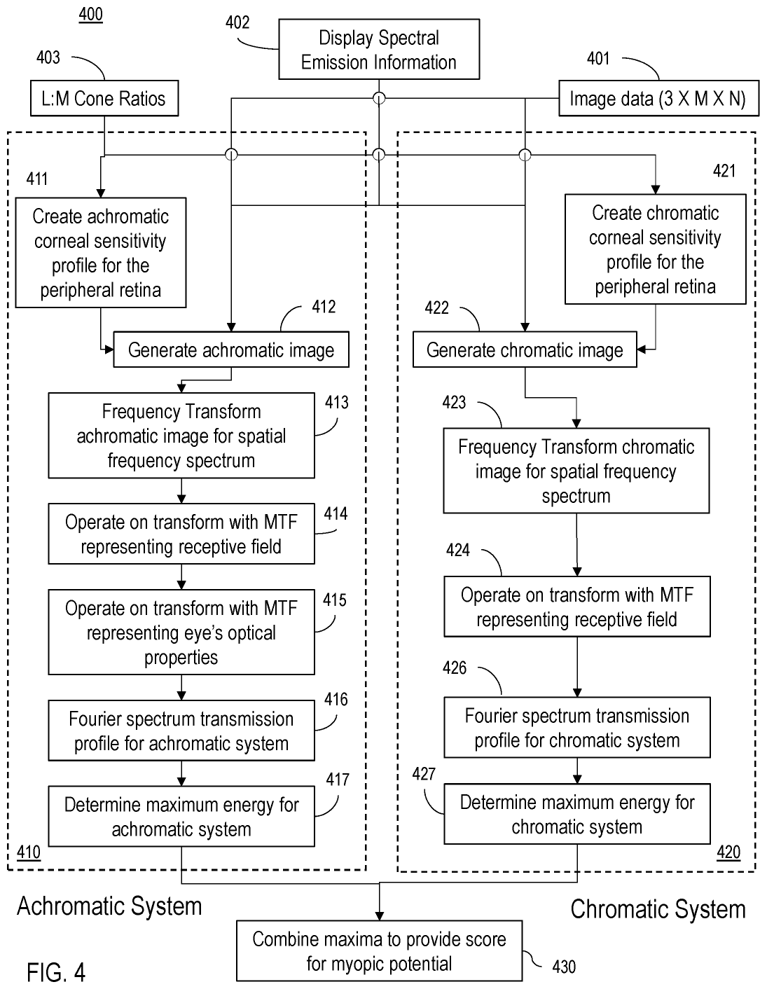

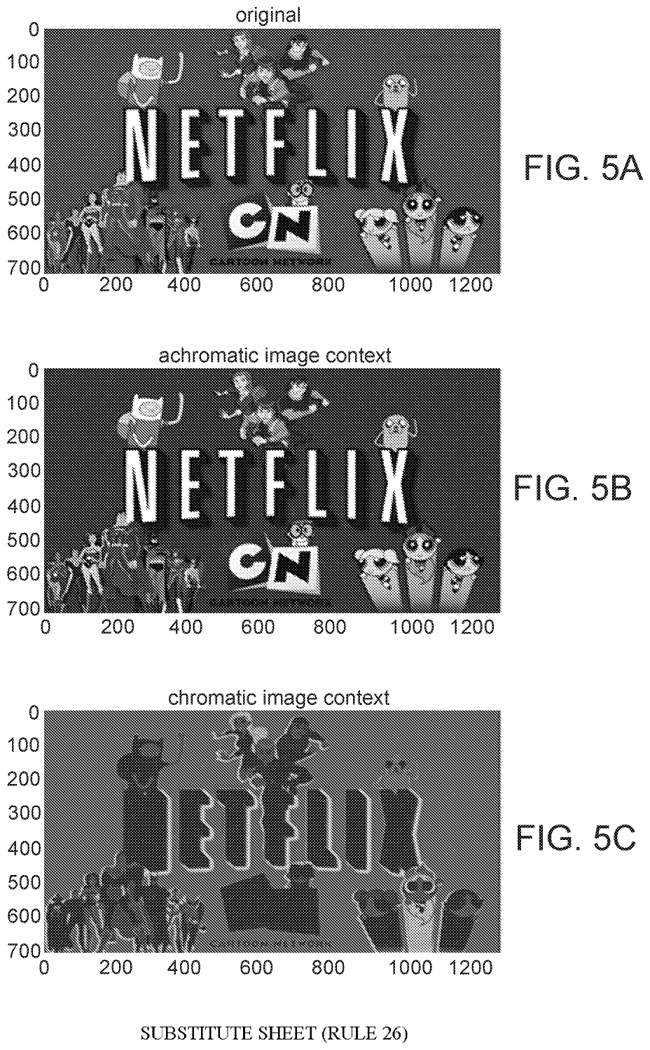

Referring to FIG. 4, an example algorithm 400 for determining myopic potential uses image data (401), display spectral emission information (402), and information about L:M cone ratios (403) as inputs. Image data 401 can be in the form of a 3×M×N matrix, where M×N refers to the image resolution (rows×columns) and 3 is the number of sub-pixels (e.g., R, G, B). For purposes of illustration, FIG. 5A shows an example of an image that includes a large amount red along with regions composed principally of non-red colors but with substantial contrast variation over varying length scales.

Display spectral emission information 402 refers to information about the spectral emission of each sub-pixel in a display. This can be a spectral emission profile for each sub-pixel. This information can be obtained from empirical measurements of each display type or obtained from another source, such as the OEM of the display panel, for example.

The L:M cone ratio refers to the ratio of L cones to M cones for the user. This information can be determined empirically for each individual user. One technique capable of measuring L:M ratio is the color flicker photometric electroretinogram (ERG) (Jacobs and Neitz, J Opt Soc Am A, 1, 1175-1180 (1984)), and a second technique capable of measuring L:M ratio is retinal densitometry (RD) (Sabesan R. et al., PLoS One, (2015)). Both techniques rely on the ability to provide specific wavelengths of light in known quantities to the eye while measuring the relative absorption of that light, either electrically as in the ERG technique, or optically as in the RD technique.

In such circumstances, algorithm 400 can yield a myopic potential value tailored to an individual user based on a measurement of the individuals L:M cone ratio using a specific display, e.g., based on spectral emission information for the particular type of display. Alternatively, myopic potential for an image can be determined based on non-user specific information, e.g., from an estimate of the user's L:M cone ratio (e.g., based on factors like the user's race).

Algorithm 400 splits the calculation into an achromatic system 410 and a chromatic system 420. Each of these systems yield a corresponding myopic potential score, which are combined to yield the final myopic potential score for the image (step 430).

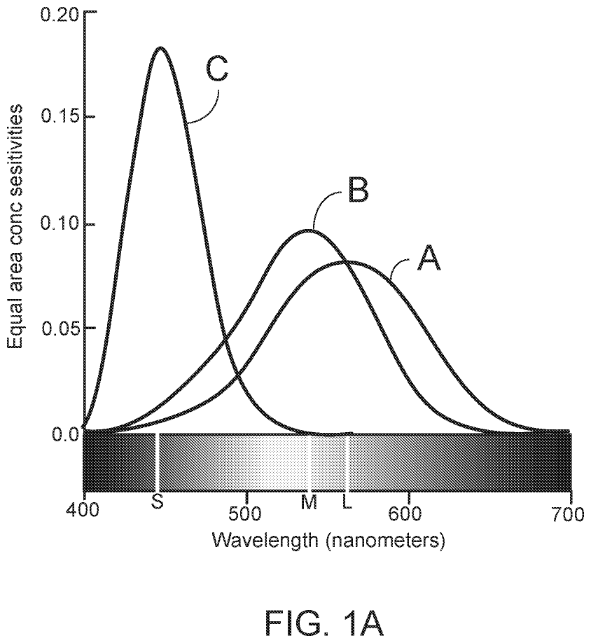

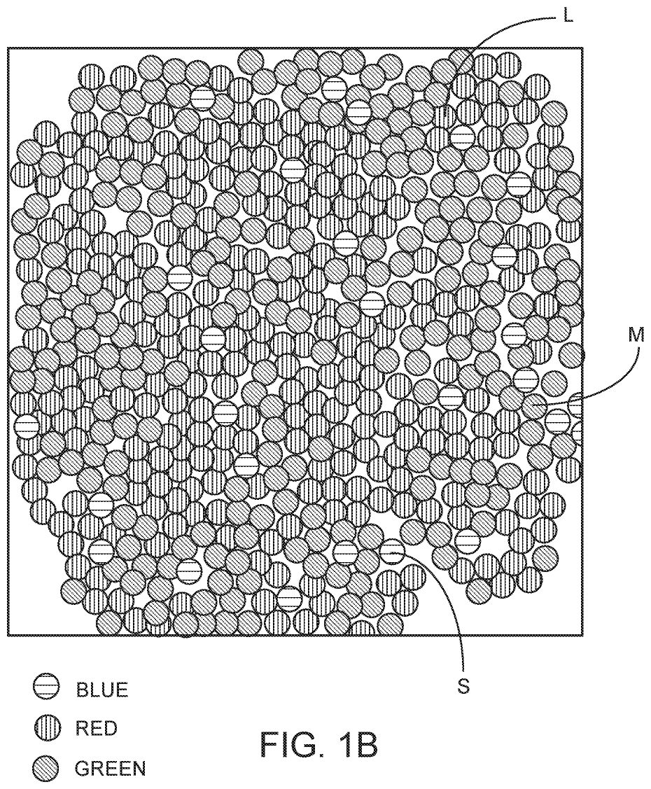

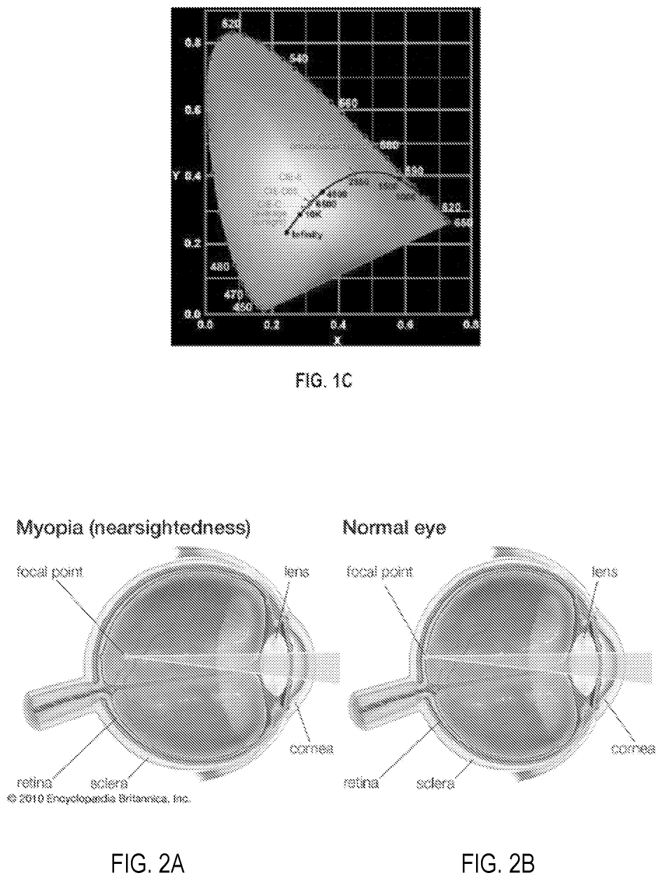

Turning first to achromatic system 410, the initial step 411 is to create an achromatic corneal sensitivity profile for the user's peripheral retina. To do this, algorithm 400 uses L:M cone ratio 403 along with cone sensitivities (see, e.g., FIG. 1A) for the L and M cones. The achromatic corneal sensitivity profile can be determined from the weighted sum of the cone sensitivities at each wavelength, where the weights are the ratio of each cone type. The sensitivity can also account for other factors, such as absorption of the human eye at each wavelength.

Mathematically, the achromatic sensitivity of the eye, or V_{λ}, can be calculated using equation 1 below, where L is the sensitivity of the L-cone as a function of wavelength, M is the sensitivity of the M-cone as a function of wavelength, and Lens is the van Norren estimate of the yellowness of the human lens.

V_{A}=Lens(λ)·(L_{%cr}·L(λ)+M_{%cr}·M(λ)). (1)

An example achromatic corneal sensitivity profile is shown in FIG. 6A, which exhibits a Gaussian-like bell curve shape with peak sensitivity in the 550 nm to 600 nm range.

Once the achromatic corneal sensitivity profile for the user's retina has been established, algorithm 400 uses this information along with display spectral emission information 402 to generate an achromatic image (step 412). This step involves determining the spectrum of each pixel as shown by the display based on image data (401) and display spectral emission information (402). Convolving the achromatic corneal sensitivity profile with the spectral content of each pixel results in an achromatic image for which each pixel value corresponds to a relative stimulus amount of the viewer's L and M cones by that pixel. FIG. 5B illustrates this effect for the image in FIG. 5A.

Next, algorithm 400 uses a frequency transform (e.g., a Fourier transform) to generate a spatial frequency spectrum of the achromatic image (step 413).

Algorithm 400 then operates on the achromatic spatial frequency spectrum with a modulation transfer function (MTF) that represents the receptive field on the retina (step 414). Algorithm 400 also operates on the achromatic spatial frequency spectrum with a MTF that represents various optical properties of the user's eye (step 415). Mathematically, the MTFs relate the magnitude of the eye's response to sinusoids of different spatial frequency.

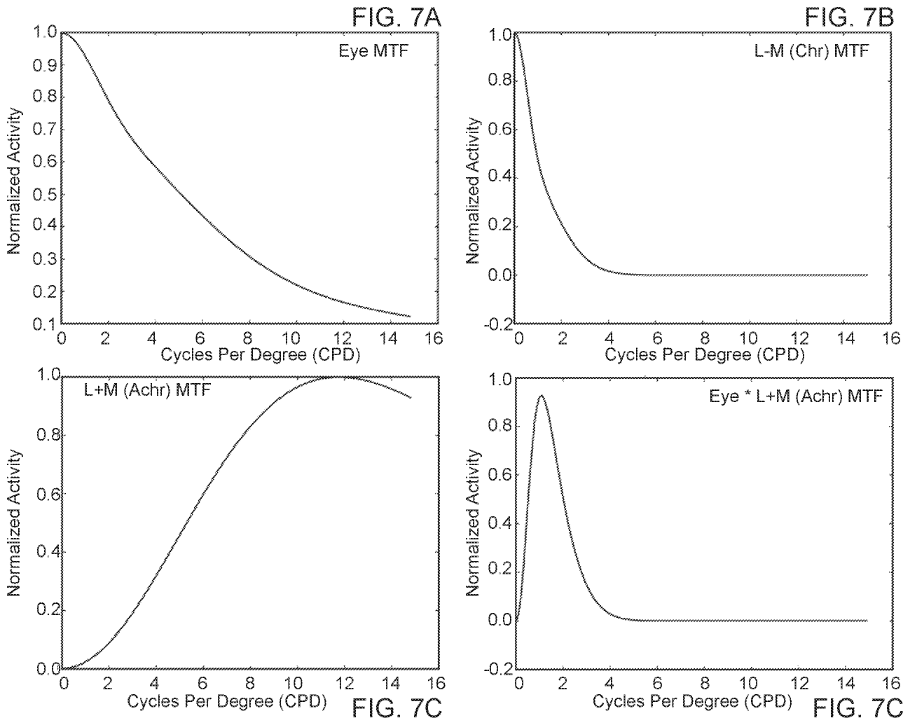

The first MTF (eyeMTF) describes how the optics of the eye blurs light as a function of spatial frequency, more commonly referred to as the point spread function. A plot showing an exemplary MTF is shown in FIG. 7A. Specifically, this plot shows normalized activity as a function of cycles per degree (CPD). As illustrated in this plot, low frequency content (e.g., 2 CPD and lower) passes virtually unchanged (i.e., activity is high), but higher spatial frequency content (e.g., 8 CPD and higher) gets diffused creating less cone contrast (i.e., activity is low, such as 20% or less of the maximum activity) in an inverse relationship to frequency.

The second MTF for the achromatic system can be generated by integrating sinusoids from DC to ˜100 cycles per degree (CPD) with a difference of Gaussian center-surround receptive field. A plot showing an exemplary MTF is shown in FIG. 7B. In this example, there is zero activity for DC stimuli, and low frequency content has relatively low activity. Activity increases monotonically for frequencies up to a maximum at approximately 12 CPD, and activity decreases for lower frequencies.

The sum of those products become the mathematical representation for how the retina will respond to achromatic frequencies present in an image. The two modulation transfer functions are multiplied together in frequency space which leads to the mathematical estimate of the myopic potential due to the achromatic component of the image. By way of example, equation 2 describes the achromatic pathway, where c is the cone diameter, and cpd is frequency.

$$AchromaticMTF ( cpd ) = eyeMTF ( cpd ) \cdot {\int }_{0}^{100} sin ( cpd ) \cdot [ {e}^{- ( \frac{{cpd}^{2}}{2 {c}^{2}} )} - \frac{1}{3} {e}^{- ( \frac{{cpd}^{2}}{2 {( 3 c )}^{2}} )} ] dcpd \qquad ( 2 )$$

The net effect of the two MTFs is illustrated in FIG. 7C, which shows normalized activity as a function of spatial frequency in cycles per degree. Activity is zero for DC, but increases rapidly to a peak at about 2 CPD, before decreasing rapidly at higher frequencies. Activity is negligible for spatial frequencies above about 4 CPD in this example.

Accordingly, these operations yield a Fourier spectrum transmission profile for the achromatic system (416) and algorithm 400 selects the maximum energy of this spectrum (step 417) as the myopic potential score for achromatic system 410.

The achromatic system described above handles spatial frequency content (e.g., text on a page) that is altered when it passes through the cornea and lens, and is sampled by the L- and M-opponent system.

However, low spatial frequency spectral content can preferentially modulate one cone class over another creating a high spatial frequency retinal contrast independent of the eye's modulation transfer function. For example, turning a display on with just the red primary will produce a low spatial frequency component that drives L-cones greater than M-cones creating high frequency content on the retina. The point spread function has virtually no effect on a diffuse chromatic light, and therefore a second mathematical construct is used to model this kind of contrast separately, herein referred to as L-M. This second mathematical construct is used in chromatic system 420, which includes similar steps to achromatic system 410.

The first step 421 is to create a chromatic corneal sensitivity profile for the user's peripheral retina. Algorithm 400 uses L:M cone ratio 403 to calculate this along with cone sensitivities (see, e.g., FIG. 1A) for the L and M cones. The chromatic corneal sensitivity profile can be determined from the weighted difference of the cone sensitivities at each wavelength, where the weights are the ratio of each cone type. The sensitivity can also account for other factors, such as absorption of the human lens at each wavelength. An essential final aspect to the L-M system is that it is tuned such that white light produces no output Equation 3 is an example mathematical formula for determining the chromatic sensitivity. Here, L is the sensitivity of the L-cone as a function of wavelength, M is the sensitivity of the M-cone as a function of wavelength, Lens is the van Norren estimate of the yellowness of the human lens, EE is equal energy white light, and x is a gain variable set such that the summation of this function=0.

L−M=EE(λ)·(Lens(λ)·(x−L(λ)−(1−x)·M(λ)). (3)

An example chromatic corneal sensitivity profile is shown in FIG. 6B, which exhibits a minimum at about 500 nm and a maximum at about 600 nm.

Once the chromatic corneal sensitivity profile for the user's retina has been established, algorithm 400 uses this information along with display spectral emission information 402 to generate a chromatic image (step 422). FIG. 5C shows an example of a chromatic image. This image corresponds to the image shown in FIG. 5A and shows that chromatic contrast occurs principally for those pixels in which the red primary is greater than the green primary.

Next, algorithm 400 uses a frequency transform (e.g., a Fourier transform) to generate a spatial frequency spectrum of the chromatic image (step 423). Algorithm 400 then operates on the chromatic spatial frequency spectrum with a MTF that represents the receptive field on the retina (step 424). Equation 4 shows an example of such a chromatic pathway. Here, c is the receptive field size and cpd is frequency.

$$ChromaticMTF ( cpd ) = {\int }_{0}^{100} sin ( cpd ) \cdot [ {e}^{- ( \frac{{cpd}^{2}}{2 {c}^{2}} )} + \frac{1}{3} {e}^{- ( \frac{{cpd}^{2}}{2 {( 3 c )}^{2}} )} ] dcpd . \qquad ( 3 )$$

The plot in FIG. 7D graphically illustrates this MTF. DC signals pass unaltered, but as frequency increases, the chromatic signals antagonistically interact with the center and surround decreasing the output of the system until a null is reached.

These operations yield a Fourier spectrum transmission profile for the chromatic system (426) and algorithm 400 selects the maximum energy of this spectrum (step 427) as the myopic potential score for chromatic system 420.

Algorithm 400 provides a value for a myopic potential for a single image. However, the algorithm can be applied to media composed of more than one image. For instance, videos can be evaluated this way, e.g., by evaluating each frame and combining (e.g., summing, averaging, or by some other mathematical operation) each frame's score to provide a composite score.

Moreover, while the foregoing description provides specific examples of various operators that are used to determine the achromatic and chromatic contributions to the myopic potential, it will be understood that other mathematical operations can be used. For example, while the examples of the MTF's for the achromatic and chromatic stimulus of the retina are, functionally, an integral of a product of a harmonic function in with a sum or difference of two gaussians, other functional forms of these MTFs can be used. Another example of a MTF to describe center-surround antagonism is one constructed of multiple individual gaussians. A cone (or cones) representing the center and a cone (or cones) representing the surround would each be modeled by an individual gaussian of unique weight and sign, where the standard deviation would be equal to each cone's sensitivity profile to incoming quanta.

Alternative mathematical constructs capable of providing a similar myopiagenic metrics may include a physical model of the eye and retina. In such methods, an in silico retina can be generated with L-, M-, and S-cones with accurate density, size, and distribution. Display images would be aberrated by the cornea as it passed through, altered by the lens as a function of age, and ultimately land, in appropriate size and scale on the generated retina. Then, center-surround outputs of each cone type would yield alternative access to contrast mechanisms responsible for myopia.

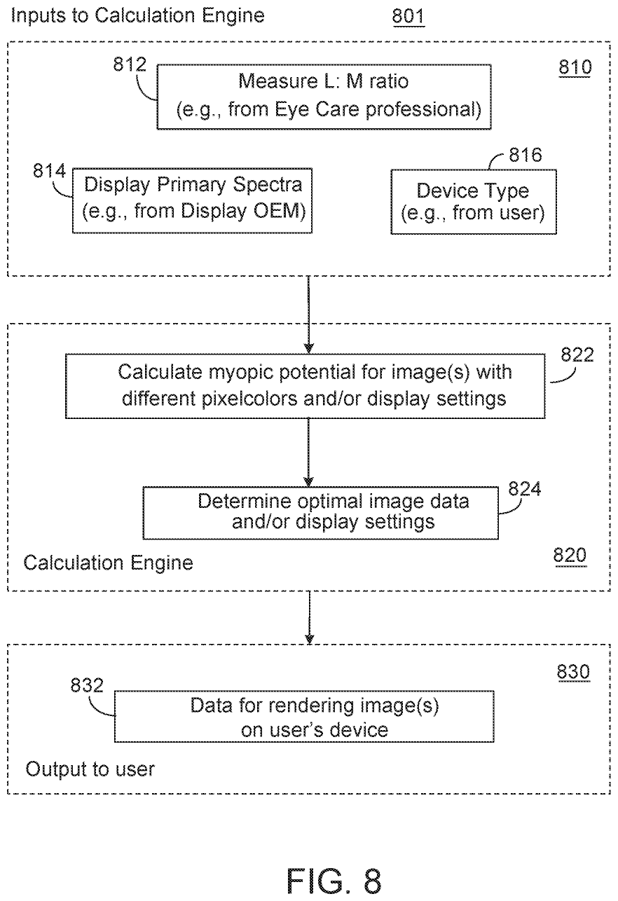

In some implementations, algorithms (e.g., algorithm 400) that evaluate myopic potential can be used to determine adjusted image data and/or display color settings for a specific user and a specific display used by that user to reduce myopic potential of displayed images for the display. For example, referring to FIG. 8, a method 801 for determining adjusted image data and/or settings for a user's display uses a calculation engine 820 which receives a series of inputs 810 and outputs 830 recommendations to a user for color settings for the user's device.

Inputs 810 include L:M cone ratio information for the user 812, the primary spectra for the user's display 814, and the user's device type 816.

L:M cone ratio information includes the L:M cone ratio for each of the user's eyes, which can be obtained empirically (e.g., from measurements from an eye care professional or other technician). Primary spectra for the user's display 814 can also be determined empirically (e.g., by spectral measurements) or obtained, e.g., from the display OEM or other source. In certain cases, the primary spectra are obtained from a database on spectra for various different types of display based on the user's device type 816.

The calculation engine calculates a myopic potential for one or more images displayed for the user and the user's display (step 822). The images can be provided by the user, or can be one or more of a set of standard images (e.g., typifying different types of media likely to be viewed by the user). Examples of standard images include pages of text (e.g., rendered in black and white) and color images of various objects or scenes.

Based on the myopic potential calculations, the calculation engine determines adjusted image data and/or optimal display settings for the image(s) (step 824). The calculation engine can determine the optimal display settings by adjusting pixel colors for at least some of the pixels in the image and recalculating myopic potential to determine whether the color changes yield a lower score. For example, the red saturation of the images can be reduced and/or variations in the image contrast at spatial frequencies where the achromatic image has a large response can be reduced. The calculation engine can repeat this process until a threshold value for myopic potential for the image has been achieved.

Alternatively, or additionally, the calculation engine can scale the primary spectra for the display and repeat the myopic potential calculation using the modified display primary spectra. For example, the calculation engine can perform the myopic potential calculation for different relative intensities of the red primary until a threshold value for myopic potential has been achieved.

Finally, the calculation engine modified image data and/or display settings to the for rendering the image(s) on the user's device (step 832).

In general, the calculation can be performed by the user's device or by some other remote device (e.g., a server).

By calculating a quantifiable value for myopic potential by an image, it is possible to quantify the degree to which a image will differentially stimulate L cones and M cones. This quantification allows for the scoring of a stimulus (e.g., a particular image, a video file), which in turn—by comparing scores—allows for the objective comparison of the myopic potential of different media.

In general, the myopic potential can be normalized to a scale or assigned some other identifier indicative of the content's myopic potential. For example, the value can be presented as a value in a range (e.g., from 1 to 10), as a percentage, or by some other alphanumeric identifier (e.g., as a letter grade), color scale, or description.

Myopiagenic scales for content, such as the scale described above, may be useful in many ways. For example, a scale allows one to rate content (e.g., movies or other video files) as to its myopic impact on a viewer.

A scale also provides an objective way to measure algorithms that modify images, including changing colors of images, such as the algorithms disclosed in U.S. 2014/0063347A1, entitled “MYOPIA-SAFE VIDEO DISPLAYS,” filed Apr. 20, 2012; U.S. Ser. No. 15/409,049, entitled “METHODS FOR DISPLAYING AN E-BOOK USING A COMBINATION OF COLORS FOR TEXT AND BACKGROUND THAT HAVE A REDUCED MYOPIAGENIC EFFECT,” filed Jan. 18, 2017; and PCT/US2017/013969 entitled “METHOD AND APPARATUS FOR REDUCING MYOPIAGENIC EFFECT OF ELECTRONIC DISPLAYS,” filed Jan. 18, 2017, for example. They can be used to rate efficacy of algorithms designed to increase or decrease differential L:M cone stimulation. For example, one can compare algorithms by comparing the score of a common video file after it is modified using a respective algorithm. In some embodiments, one can compare the effect on myopic potential reduction of algorithms having differing computational efficiencies using the scale. For instance, one can evaluate the tradeoff between an algorithm that modifies every frame in a video file, versus one that modifies fewer frames (e.g., every other frame, every third frame, etc.). Similarly, one can evaluate the tradeoff between algorithms that evaluate every pixel versus sampling pixels within frames.

While the examples herein describe electronic images and videos, the skilled artisan will appreciate that such a scale may be useful in the non-digital world, for example to rate the myopic impact of printed media, including books, newspapers, board games, etc. Light reflected from such physical media could be measured and retinal stimulation could be calculated in the manner set forth above.

Quantitative myopiagenic scales may be useful in the design of products in addition to evaluating media. For example, myopiagenic scales can be used to evaluate combinations of colors in certain types of displays and identify those color combinations rating favorably on the myopiagenic scale.

Such color combinations are useful when displaying text, in particular, which is commonly displayed using black text on a white background at the maximum contrast allowed by the display. However, it is believed that the high level of contrast between the text and background produces high levels of contrast at a viewer's retina, which in turn leads myopia. Accordingly, it is believed that the myopiagenic effects of reading may be reduced by selecting a color combination offering relatively low overall cone contrast. This may be useful in displaying text in various settings, including but not limited to e-book hardware, e-book software, word processing software, and the like.

Accordingly, a myopiagenic scale, such as the one described above, may be useful for selecting color combinations for displaying text. This can be accomplished by evaluating, using the scale, different combinations of colors for text and background.

In general, e-reader or word processing solutions based on the above may be implemented in a variety of ways. For example, in an e-reader with a color display or an e-reader application on a mobile device, color combinations with favorable myopiagenic scores and readability scores may be selected by the user as an option. For example, during setup or via a settings menu, the e-reader can present the user with a variety of color combination options, from which the user can selected a desirable choice. This is advantageous because preferred color combinations are expected to vary from user to user and providing a selection of choices will allow each user to use a color combination most desirable to them. By analogy, word processing solutions could be determined in a similar fashion.

Monochrome e-readers, on the other hand, such as those using electrophoretic displays, may be used having color combinations have reduced myopiagenic scores and relatively good readability based on scales such as the those described above. In some implementations of monochrome e-readers, each pixel is composed of one or more “microcapsules” containing two types of pigmented particles having opposite charge. When a charge is applied to a particular pixel, the particles having like charge are repelled from one side of the pixel to the other, and those having opposite charge are attracted. Accordingly, by reversing the charge on the pixel, the pixel can take on the color of one pigment or the other, or various combinations of the two depending on how long the charge is applied. According, in embodiments, pigments can be selected (alone or in combination with black and/or white pigments) to correspond to color combinations that have reduced myopiagenic scores relative to black and white pigments. When displayed, such pigment combinations can reduce contrast between adjacent neurons of the retina and/or reduce center-surround antagonism.

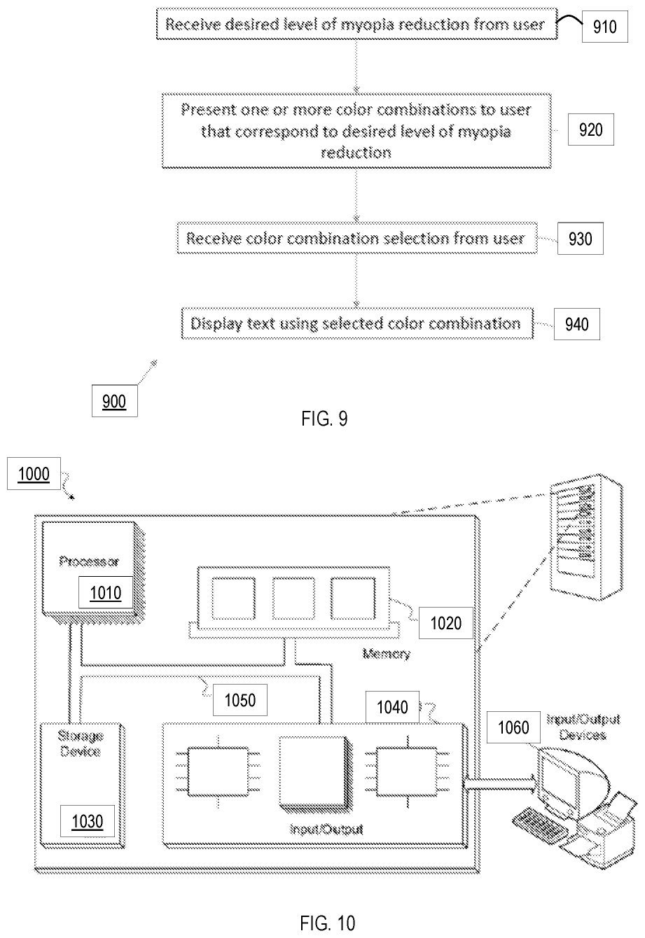

In some embodiments, a user can input a desired level of myopia reduction and the e-reader returns a selection of color combinations that correspond to the desired level. For example, FIG. 9 shows an algorithm 900 in which a user can select text-background color combinations having a desired level of myopia reduction. Here, as part of the e-reader setup or within a menu of options that are part of the e-reader's operating system, for example, the e-reader presents the user with an interface, such as an input box, slider, dropdown box, radio buttons, or other input tool, in which the user can input a desired level of myopia reduction. The desired level can be a minimum amount of myopia reduction, a range of myopia reduction values, or a single value indicative of the desired level. Levels may be expressed as a percentage (e.g., where the most myopiagenic combination corresponds to 0% reduction and the most myopia reducing combination is 100%) or on some other scale (e.g., from 0 to 10 or some other alphanumeric scale).

Upon receiving the user's input (step 910), algorithm 900 retrieves color combinations corresponding to the level designated by the user and presents one or more combinations to the user (step 920). The color combinations can be calculated using a myopia scale such as by the algorithm, or can be calculated beforehand and stored in a database (e.g., locally or remote) that is accessed by the algorithm.

The number of color combinations presented to the user can vary. For example, the algorithm can present only a subset of combinations that most closely match the user's desired level (e.g., 10 or fewer, 8 or fewer, 5 or fewer). In some implementations, the algorithm can present those color combinations that match the user's desired myopia reduction level within a certain range (e.g., within 10% of the desired level, within 5%, within 2%, within 1%).

Upon viewing the presented color combinations, the user selects the desired combination. Upon receiving the selection (step 930), the algorithm displays text using the selected color combination (step 940).

In some embodiments, the algorithm can present color combinations to the user based on one or more criteria in addition to the desired level of myopia reduction. For instance, the user can be presented color combinations based on a readability score (see above) in addition to level of myopia reduction. Alternatively, the user can be presented color combinations based on the preferences gathered from other users or the preferences previously expressed by a particular user and/or derived by previous behavior of a particular user or group of users.

In some embodiments, the algorithm includes a recommendation engine that provides a selection of myopia-reducing color combinations based on the nature of content in the e-book. For instance, the recommendation can vary depending on whether the e-book is primarily text (e.g., a novel or nonfiction book), contains both text and figures (e.g., a textbook, magazine, or newspaper), or is primarily figures (e.g., a graphic novel or comic). Recommended color combinations for different e-book content can be based on a myopiagenic scale (e.g., the LMS scale described above) which is used to evaluate the myopiagenic effect of different types of content. Alternatively, or additionally, recommendations can be based on data collected and observed about user preferences (e.g., the individual user in front of the screen at the moment, broad sets of user data about which is accumulated over time from many users, or both) that may be preferable or suitable for e-reading different types of content.

In certain implementations, an e-reader can include modes for users: a conventional mode that displays e-books using conventional color schemes, and a myopia-safe mode for displaying e-books using a color combination with a reduced myopiagenic effect compared to the conventional mode. In other words, different color combinations can be associated with different accounts on device. For example, an e-reader can feature a user experience that allows a parent to create settings for children (e.g., one or more) as well as themselves that have different myopia reduction levels. In other words, kids may not be able to select color combinations when operating the e-reader under their account (or at least have a reduced ability to change display colors). Accordingly, in certain implementations, an administrator (e.g., adult account) can associate color combinations with a myopia-reduced mode which will then be used by the e-reader when e-books are accessed using certain user accounts (e.g., children's accounts).

Moreover, in certain embodiments, the color combinations used to present text and background can vary (automatically, or upon prompting) over time. For instance, in some embodiments, a myopia-reduced mode can begin a reading session using a color combination have a first level of myopia reduction and change the color combination as the reading session progresses. For example, colors with increasing myopia reduction can be used as a reading session progresses (e.g., as measured by time or progress in reading the content). The color changes can happen automatically. Alternatively, the user can be prompted to change the color combination as the reading session progresses. In some embodiments, the e-reader can change between color combinations that have similar myopia scores as a reading session progresses, e.g., simply to present a change for the user. Myopia-reduced color combinations can be implemented in an e-reader in a variety of ways. For example, myopia-reduced color combinations can be included as part of the operating system of the e-reader as discussed above. Alternatively, the myopia-reduced color combinations can be implemented via software as an add-on to existing e-reader programs or as standalone e-reader applications that can be installed on an e-reader, other mobile device, or any other device used for reading e-books.

In general, any format e-book can be displayed using a combination of colors that have a reduced myopia potential compared to black and white, including (without limitation) Broadband eBooks (BBeB) (e.g., e-book files using extensions .lrf; .lrx), Comic Book Archive file (e.g., e-book files using file extensions .cbr (RAR); .cbz (ZIP); .cb7 (7z); .cbt (TAR); .cba (ACE)), Compiled HTML (e.g., e-book files using extension .chm), DAISY—ANSI/NISO Z39.86, DjVu (e.g., e-book files using extension .djvu), DOC (e.g., e-book files using extension .DOC), DOCX (e.g., e-book files using extension .DOCX), EPUB (e.g., e-book files using extension .epub), eReader (e.g., e-book files using extension .pdb), FictionBook (e.g., e-book files using extension .fb2), APABI (e.g., e-book files using extensions .xeb; .ceb), Hypertext Markup Language (e.g., e-book files using extensions .htm; .html and typically auxiliary images, js and css), iBook (e.g., e-book files using extension .ibooks), IEC 62448, INF (e.g., e-book files using extension .inf), KF8 (Amazon Kindle) (e.g., e-book files using extensions .azw3; .azw; .kf8), Microsoft LIT (e.g., e-book files using extension .lit), MOBI or Mobipocket (e.g., e-book files using extensions .prc; .mobi), Multimedia eBooks (e.g., e-book files using extensions .exe or .html), Newton eBook (e.g., e-book files using extension .pkg), Open Electronic Package (e.g., e-book files using extension .opf), Portable Document Format (e.g., e-book files using extension .pdf), Plain text files (e.g., e-book files using extension .txt), Plucker (e.g., e-book files using extension .pdb), PostScript (e.g., e-book files using extension .ps), Rich Text Format (e.g., e-book files using extension Alf), SSReader (e.g., e-book files using extension .pdg), Text Encoding Initiative (e.g., e-book files using extension .xml), TomeRaider (e.g., e-book files using extensions .tr2; .tr3), and Open XML Paper Specification (e.g., e-book files using extensions .oxps, .xps).

Aspects of the systems and methods described here can be implemented in digital electronic circuitry, or in computer software, firmware, or hardware, including the structures disclosed in this specification and their structural equivalents, or in combinations of one or more of them. For example, in some implementations, the algorithms disclosed above can be executed using digital electronic circuitry, or in computer software, firmware, or hardware, or in combinations of one or more of them.

The term “electronic processing module” encompasses all kinds of apparatus, devices, and machines for processing data and/or control signal generation, including by way of example a programmable processor, a computer, a system on a chip, or multiple ones, or combinations, of the foregoing. The module can include special purpose logic circuitry, e.g., an FPGA (field programmable gate array) or an ASIC (application specific integrated circuit). The module can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The module and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes described above can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a flat panel display, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computing system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

FIG. 10 shows an example electronic processing module 1000 that includes a processor 1010, a memory 1020, a storage device 1030 and an input/output device 1040. Each of the components 1010, 1020, 1030 and 1040 can be interconnected, for example, by a system bus 1050. The processor 1010 is capable of processing instructions for execution within the system 1000. In some implementations, the processor 1010 is a single-threaded processor, a multi-threaded processor, or another type of processor. The processor 1010 is capable of processing instructions stored in the memory 1020 or on the storage device 1030. The memory 1020 and the storage device 1030 can store information within the module 1000.

The input/output device 1040 provides input/output operations for the module 800. In some implementations, the input/output device 1040 can include one or more network interface devices, e.g., an Ethernet card, a serial communication device, e.g., an RS-232 port, and/or a wireless interface device, e.g., an 802.11 card, a 3G wireless modem, a 4G wireless modem, a LTE wireless modem, etc. In some implementations, the input/output device can include driver devices configured to receive input data and send output data to other input/output devices, e.g., keyboard, printer and display devices 1060. In some implementations, mobile computing devices, mobile communication devices such as smart phones or tablet computers, and other devices can be used.

Other embodiments are in the following claims.

1. A method for evaluating differential stimulation of L and M cones in a viewer's eye by an image displayed on a color display, the method comprising:
receiving information about the spectral emission properties of the color display;
receiving image data about the image;
determining an achromatic component of the image based on one or more pixels of the image and the information about the spectral emission properties of the color display, the achromatic component representing differential stimulation of L and M cones due to contrast variations in the image;
determining a chromatic component of the image based on one or more pixels of the image and the information about the spectral emission properties of the color display, the chromatic component representing differential stimulation of L and M cones due to a spectral content of the image; and
evaluating the differential stimulation of L and M cones in the viewer's eye by the image displayed on the color display based on the chromatic and achromatic components.

2. The method of claim 1, further comprising adjusting a color setting of the color display and displaying the image on the color display, wherein the adjusted color setting causes the displayed image to cause a lower differential stimulation of L and M cones in the viewer's eye relative to displaying the image using the unadjusted display.

3. The method of claim 1, wherein the evaluation comprises using a first modulation transfer function to represent how the viewer's retina responds to different spatial frequencies present in the achromatic component for the image.

4. The method of claim 3, wherein the evaluation further comprises using a second modulation transfer function to represent how the viewer's eye blurs light as a function of spatial frequency.

5. The method of claim 1, wherein the evaluation comprises using a third modulation transfer function to represent how the viewer's retina responds to different spatial frequencies present in the chromatic component of the image.

6. The method of claim 5, wherein the first and third modulation transfer functions represent a receptive field of a midget bipolar cell.

7. The method of claim 1, wherein determining the achromatic component comprises creating an achromatic corneal sensitivity profile for the viewer's eye based on a ratio of L cones to M cones in the viewer's eye and determining the chromatic component comprises creating a chromatic corneal sensitivity profile for the viewer's eye based on a ratio of L cones to M cones in the viewer's eye, the achromatic corneal sensitivity profile being indicative of a combined sensitivity of the M cones and L cones in the viewer's eye and the chromatic corneal sensitivity profile being indicative of a differential sensitivity of the M cones and L cones in the viewer's eye.

8. The method of claim 7, wherein the ratio of L cones to M cones in the viewer's eye is obtained from a measurement of the viewer's eye.

9. The method of claim 7, wherein determining the achromatic component comprises generating an achromatic representation of the image based on the achromatic corneal sensitivity profile and the spectral emission properties of the color display, and determining the chromatic component comprises generating an achromatic representation of the image based on the chromatic corneal sensitivity profile and the spectral emission properties of the color display.

10. The method of claim 9, wherein the achromatic and chromatic components account for light absorption by the lens of the viewer's eye.

11. The method of claim 10, wherein evaluating the differential stimulation of L and M cones in the viewer's eye by the image comprises determining a spatial frequency spectrum of the achromatic representation of the image.

12. The method of claim 1, wherein the information about the spectral emission properties of the color display comprises a spectral profile for each sub-pixel color of the color display.

13. The method of claim 12, wherein the color display comprises red, green, and blue sub-pixel colors or cyan, magenta, and violet sub-pixel colors.

14. The method of claim 1, wherein the image data comprises a value for each sub-pixel display color for each pixel in the image.

15. The method of claim 14, wherein the sub-pixel display colors are red, green, and blue or cyan, magenta, and violet.

16. The method of claim 1, wherein the image comprises text.

17. The method of claim 1, further comprising providing information the viewer about a myopic potential of the image when viewed on the display based on the evaluation.

18. A system, comprising:
an electronic processing module programmed to:
receive information about spectral emission properties of a color display;
receive image data about an image;
determine an achromatic component of the image based on one or more pixels of the image and the information about the spectral emission properties of the color display, the achromatic component representing differential stimulation of L and M cones due to contrast variations in the image;
determine a chromatic component of the image based on one or more pixels of the image and the information about the spectral emission properties of the color display, the chromatic component representing differential stimulation of L and M cones due to a spectral content of the image; and
evaluate differential stimulation of L and M cones in a viewer's eye by the image displayed on the color display based on the chromatic and achromatic components.

19. A method for presenting an image using a color display, comprising:
receiving information about the spectral emission properties of the color display;
receiving image data about the image;
calculating information indicative of an amount of differential stimulation of L and M cones in a viewer's eye when viewing the image on the display based on the spectral emission properties of the display;
identifying one or more color settings for the color display to reduce differential stimulation of L and M cones in the viewer's eye when the viewer view's the image using the color display; and
transmitting the one or more color settings to the display.

20. The method of claim 19, further comprising receiving information about a subject's L:M cone ratio, wherein the information indicative of an amount of differential stimulation of L and M cones in a viewer's eye when viewing the image on the display is calculated based on the L:M cone ratio.

21-25. (canceled)
